(19) United States
(12) Patent Application Publication
(10) Pub. No.: US 2019/0360392 A1
(43) Pub. Date: Nov. 28, 2019

(54) METHOD FOR CONTROLLING THE QUANTITY OF COMPRESSED AIR INTRODUCED AT THE INTAKE OF A SUPERCHARGED INTERNAL-COMBUSTION ENGINE

(71) Applicant: IFP Energies nouvelles, Rueil-Malmaison (FR)

(72) Inventors: Thierry COLLIOU, LES COTES D'AREY (FR); Bruno WALTER, CHAGNON (FR)

(21) Appl. No.: 16/470,106

(22) PCT Filed: Nov. 30, 2017
(86) PCT No.: PCT/EP2017/080973

§ 371 Date: Jun. 14, 2019

(30) Foreign Application Priority Data
Dec. 15, 2016 (FR) 1662489

(51) Int. Cl. F02B 37/16; F02B 37/22; F02D 41/18

(52) U.S. Cl. CPC F02B 37/168; F02D 23/02; F02D 41/18; F02B 37/225

(57) ABSTRACT

The present invention relates to a method for controlling the amount of air fed to the intake of a turbocharged internal-combustion engine, comprising an intake manifold (18) and at least one exhaust gas outlet (28; 28′, 28″) connected to an exhaust manifold (26; 26′, 26″). The engine comprises a turbocharger (30) with a turbine (32) having at least one inlet (34; 34′, 34″) connected to said at least one exhaust gas outlet and with an outside air compressor (38), and at least one turbine speed amplifier circuit (Boost) with at least one transfer line (54; 54′, 54″) for transferring the compressed air from the compressor to the turbine inlet and controlled by throttling means (58; 58′, 58″). According to the invention, to be fed to the turbine through the amplifier circuit (Boost) the theoretical flow rate (Qair obj) is known, the air flow rate (Qair mes) is estimated, the two flow rates are compared, and a difference between the two flow rates, is controlled to correspond to the theoretical air flow rate.

### CROSS REFERENCE TO RELATED APPLICATIONS

Reference is made to PCT/EP2017/080973, filed Nov. 30, 2017, and French Application No. 16/62.489 filed Dec. 15, 2016, which are incorporated herein by reference in their entirety.

### BACKGROUND OF THE INVENTION

### Field of the Invention

The present invention relates to a method for controlling a device feeding an amount of air to the intake of an internal-combustion engine turbocharged by a single or twin-scroll turbocharger, notably for an engine of a motor vehicle, an industrial vehicle, or for a stationary system.

### Description of the Prior Art

As is widely known, the power delivered by an internal-combustion engine depends on the amount of air fed to the combustion chamber of this engine, with amount of air being proportional to the density of the air.

Thus, it is usual to increase the amount of air through compression of the outside air before it is allowed into this combustion chamber. This operation, known as turbocharging, can be carried out using any means such as a turbocharger or a driven compressor, which can be a centrifugal or a positive-displacement compressor.

In case of turbocharging using a single-scroll turbocharger, a rotary single-inlet turbine is connected by a shaft to a rotary compressor. The exhaust gases from the engine flow through the turbine to rotate it. This rotation is transmitted to the compressor which, compresses the outside air before it is fed into the combustion chamber.

As is better described in French patent application No. 2,478,736, it is intended to increase the compression of the outside air by the compressor even further to significantly amplify this amount of compressed air in the compression chamber of the engine.

This is achieved more particularly by increasing the rotational speed of the turbine and therefore the rotational speed of the compressor.

Part of the compressed air exiting the compressor is therefore diverted directly to the turbine inlet while mixing with the exhaust gases. This turbine is then driven by a larger amount of fluid (mixture of compressed air and exhaust gas), which allows the rotational speed of the turbine, and therefore of the compressor, to be increased (Boost). This compressor speed increase thus raises the pressure of the outside air that is compressed prior to being fed to the combustion chamber of the engine.

Thus, the compressed air has a higher density, which allows the amount of air contained in the combustion chamber to be increased.

In the case of the improvement mentioned in French patent application No. 3,024,178 filed by the applicant, a twin-scroll turbocharger is used to divert part of the compressed air exiting the compressor so that it is directly allowed into each inlet of the turbine while mixing with the exhaust gases. This causes a further increase the speed of the turbine and of the compressor, as well as the amount of air sent to the engine.

It is also known from document EP-1,138,928 to associate this amplification (Boost) with an exhaust gas recirculation (EGR).

Indeed, most diesel engines are equipped with an exhaust gas recirculation circuit, referred to as EGR circuit, for limiting the emissions of NOx contained in these gases at source.

The exhaust gas recirculation as illustrated by document EP-1,138,928 allows feeding exhaust gas from the engine to the intake of this engine.

These types of turbocharged engines, although satisfactory, however involve some significant drawbacks.

The flow of compressed air admitted at the turbine inlet(s) is not correctly controlled, which may lead to poor engine performance.

Thus, by way of example, in a case when too large an amount of compressed air is diverted into the turbine inlet, the exhaust gases entering the turbine are cooled too much by this air, which causes a decrease in the overall turbocharging efficiency.

The present invention is directed to overcoming the aforementioned drawbacks by a method for controlling a device feeding an amount of air to the intake of a turbocharged internal-combustion engine which allows meeting all engine power demands, and in particular during transient operation phases.

The invention achieves and manages a compressed air transfer from the intake to the exhaust, even when the average pressure of the compressed air at the intake is lower than that of the gases at the exhaust. All that is required is that for phases during the engine operation cycle, the pressure at the intake is higher than that at the exhaust.

### SUMMARY OF THE INVENTION

The present invention thus is a method for controlling the amount of air fed to the intake of a turbocharged internal-combustion engine, the engine comprising an intake manifold and at least one exhaust gas outlet connected to an exhaust manifold, the engine comprising a turbocharger with a turbine having at least one inlet connected to the at least one exhaust gas outlet and with an outside air compressor, and at least one turbine speed amplifier circuit with at least one transfer line for transferring the compressed air from the compressor to the turbine inlet under control by throttling, characterized in that:
from an operating point and a predetermined engine map, the target compressed air flow rate to be fed to the turbine through the amplifier circuit is known;
the real air flow rate that is allowed into the turbine through the amplifier circuit is estimated;
the two flow rates are compared; and
in a case of a difference between the two flow rates, the air flow rate fed to the turbine through the amplifier circuit is controlled to correspond to the target air flow rate.

The compressed air transfer from the compressor to the turbine inlet can be closed when the difference between the target compressed air flow rate and the estimated air flow rate is zero.

When the engine further comprises a recirculation circuit which sends the exhaust gas back to the intake manifold, the turbine speed amplifier circuit can be kept shut off in order to use only the exhaust gas recirculation circuit.

For use of the turbine speed amplifier circuit, the exhaust gas recirculation circuit can be shut off.

When the engine further comprises a recirculation circuit sending the exhaust gas to the intake manifold, the air flow rate fed to the turbine through the amplifier circuit is controlled to compensate for the recirculated exhaust gas flow rate, for simultaneous use of the turbine speed amplifier circuit and the exhaust gas recirculation circuit.

The compressed air flow rate can be estimated by measuring the intake flow rate.

The compressed air flow rate can be estimated by measuring the richness at the exhaust.

### BRIEF DESCRIPTION OF THE FIGURES

Other features and advantages of the invention will be clear from reading the description hereafter, given by way of non limitative example, with reference to the accompanying figures wherein:

FIG. 1 illustrates an internal-combustion engine with its turbocharging device used according to the invention;

FIG. 2 illustrates another configuration of FIG. 1;

FIG. 3 is a graph (engine speed (rpm) as a function of torque (N.m)) which shows the amplification zone (Boost zone) for the engine of FIGS. 1 and 2;

FIG. 4 illustrates an internal-combustion engine with its turbocharging device used according to a first variant of the invention;

FIG. 5 is a graph of engine speed (rpm) as a function of torque (N.m) which shows the amplification zone (Boost zone) and the exhaust gas recirculation zone (EGR zone) in relation to one another for the engine of FIG. 4;

FIG. 6 illustrates an internal-combustion engine with its turbocharging device used according to a second variant of the invention; and

FIG. 7 is a graph (engine speed (rpm) as a function of torque (N.m)) which shows the amplification zone (Boost zone), the exhaust gas recirculation zone (EGR zone) and the combination of the two zones for the engine of FIG. 6.

### DETAILED DESCRIPTION OF THE INVENTION

In FIG. 1, internal-combustion engine 10 comprises at least two cylinders. Here four cylinders are illustrated which are identified with reference numerals 12₁ to 12₄ from the left of the figure.

Preferably, this engine is a direct-injection internal-combustion engine, notably of diesel type, but the invention is applicable to any other type of internal-combustion engine.

Each cylinder comprises an intake 14 with at least one intake valve (not shown) which controls an intake pipe 16. Intake pipes 16 are connected to an intake manifold 18 which is supplied with air, such as compressed air, through a supply line 20.

The cylinders also comprises a burnt gas exhaust 22 having at least one exhaust valve (not shown) which controls an exhaust pipe 24.

The exhaust pipes are connected to an exhaust manifold 26 with an exhaust gas outlet. The exhaust gas outlet is connected to a turbocharger 30 for providing air compression, and more specifically to the expansion turbine 32 of the turbocharger.

As illustrated in FIG. 1, the turbocharger is a turbocharger is a turbine having a single inlet 34 that receives the exhaust gases and is rotatably connected by a shaft 36 to a compressor 38. Exhaust gas outlet 40 of the turbine is conventionally connected to exhaust line 42 of the engine.

Compressor 38 comprises an outside air intake 44 supplied by an air supply line 46. Compressed air outlet 48 of this compressor is connected to supply line 20 of intake manifold 18 by a compressed air line 50.

Advantageously, a compressed air cooling radiator 52 may be provided on line 50, between the compressor and line 20.

As is better seen in FIG. 1, a transfer line 54 allows circulation of part of the compressed air exiting compressor 38 towards inlet 34 of the turbine. More precisely, this partial transfer line originates from line 50, at an intersection point 56 between the compressor and cooling radiator 52, and ends at inlet 34 of the turbine through its junction with exhaust gas outlet 28.

The transfer line carries throttling means 58, such as a proportional valve, controlled by a control (not shown). This valve allows controlling the circulation of the compressed air passing through the transfer line. The line also comprises a non-return valve 60, which prevents circulation of the compressed air from the line to the compressor.

This configuration thus allows, during operation of the engine, to feed compressed air into the turbine for increasing the flow rate of the turbine, and therefore of the compressor. This also allows achieving more efficient turbocharging at low engine speeds.

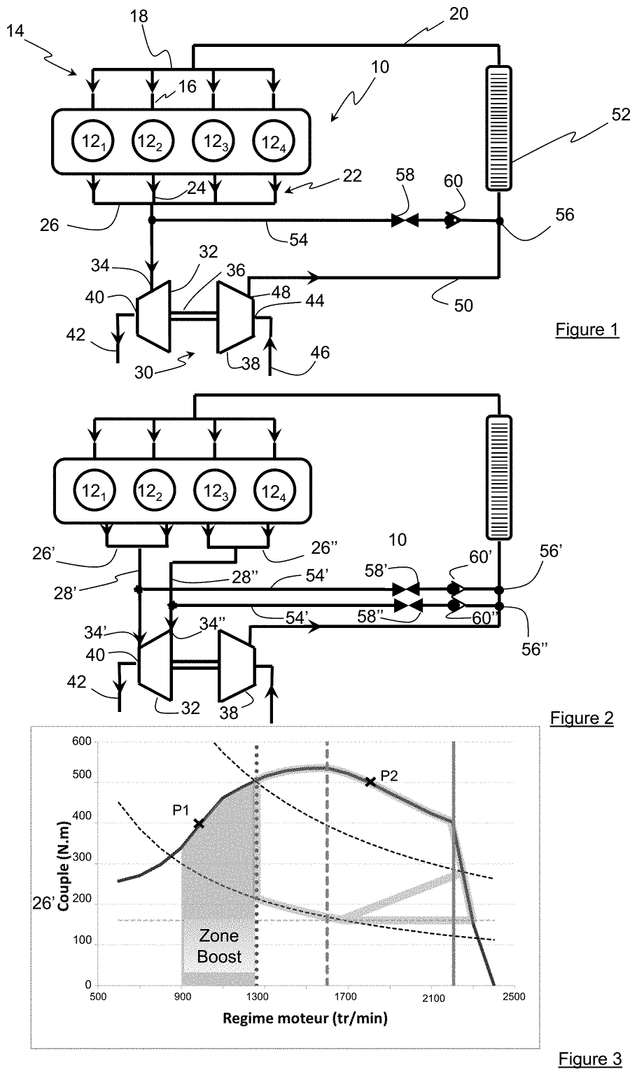

The example of the configuration of FIG. 2 differs from FIG. 1 in that the turbocharger has a turbine 32 with two inlets 34′ and 34″ (twin scroll).

In this configuration, the exhaust pipes of first cylinder 12₁ and of second cylinder 12₂, which form a first group of at least one cylinder, are connected to a first exhaust manifold 26′ with a first exhaust gas outlet 28′. The exhaust pipes of the third and fourth cylinders 12₃ and 12₄, which form a second group of at least one cylinder, are connected to a second exhaust manifold 26″ comprising a second exhaust gas outlet 28″.

The two exhaust gas outlets lead to the turbine with a first exhaust gas inlet 34′ connected to first exhaust gas outlet 28′ of first manifold 26′ and a second inlet 34″ connected to second exhaust gas outlet 28″ of second exhaust manifold 26″.

Gas outlet 40 of the turbine is conventionally connected to exhaust line 42 of the engine.

As visible in FIG. 2, instead of line 54, two transfer lines 54′ and 54″ are provided for circulating part of the compressed air exiting compressor 38 towards inlets 34′ and 34″ of the turbine.

More precisely, each partial transfer line 54′ and 54″ originates respectively from nonreturn valves 60′ and 60″, at an intersection point 56′ and 56″ between the compressor and cooling radiator 52. One 54′ of the lines ends at inlet 34′ of the turbine through its junction with first exhaust gas outlet 28′, while the other 54″ line ends at the other inlet 34″ of this turbine through its junction with second exhaust gas outlet 28″.

Each line carries throttling means 58′ and 58″, such as a proportional valve, controlled by a control that may be common to the two throttling means. This valve thus allows controlling the circulation of the compressed air passing through the line.

Advantageously, each line also comprises a non-return valve 60′ and 60″, which prevents circulation of the compressed air from the line to the compressor.

This configuration thus allows, during operation of the engine, to take advantage of the exhaust low-pressure zones occasionally prevailing in the exhaust manifolds in order to feed compressed air into the turbine and thus to increase the flow rate of this turbine, and therefore of the compressor. This also allows achieving more efficient turbocharging at low engine speeds.

As illustrated in FIG. 3, during operation of the engine, the latter can run with a turbine speed increase, as identified by the “Boost zone”, or without such a speed increase outside this zone.

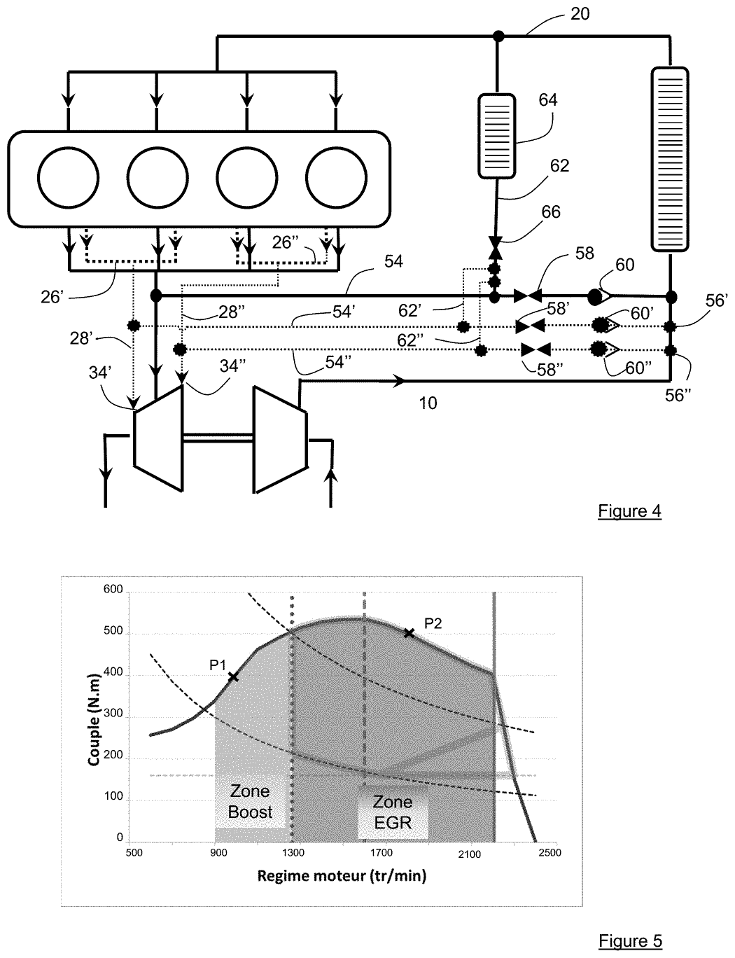

As is more visible in the variant of FIG. 4, an exhaust gas recirculation (EGR circuit) circuit which sends the exhaust gases back to the engine intake in order to limit combustion temperatures and thus NOx emissions, is provided in addition to the turbine speed amplifier circuit (Boost circuit) with transfer line 54 and its valve 58 and non-return valve 60.

A recirculation line 62 therefore connects transfer line 54 to air supply line 20.

This line preferably passes through a heat exchanger 64 suited for exhaust gas cooling and it carries throttling means 66, such as a preferably proportional valve.

In this variant, the engine can operate either with the amplifier circuit (Boost circuit) or with the exhaust gas recirculation (EGR) circuit by suitably controlling valves 58 and 66.

It should be noted that valves 58 and 66 can be replaced by a 3-way valve whose function is equivalent for controlling the various streams.

Of course, as in the configuration illustrated in FIG. 2, the turbocharger can be a turbocharger with a turbine 32 having two inlets 34′ and 34″ (twin-scroll turbine), and the engine can comprise a first exhaust manifold 26′ with a first exhaust gas outlet 28′ and a second exhaust manifold 26″ with a second exhaust gas outlet 28″.

Both exhaust gas outlets end at the turbine with a first exhaust gas inlet 34′ being connected to first exhaust gas outlet 28′ of first manifold 26′ and a second inlet 34″ being connected to second exhaust gas outlet 28″ of second exhaust manifold 26″.

As can be seen in FIG. 4, two transfer lines 54′ and 54″, which allow circulation of part of the compressed air exiting compressor 38 towards turbine inlets 34′ and 34″, are provided.

More precisely, each partial transfer line originates from line 60, at an intersection point 56′ and 56″ between the compressor and cooling radiator 52. One 54′ of the lines 54′ ends at inlet 34′ of the turbine through its junction with first exhaust gas outlet 28′; while the other 54″ line ends at the other inlet 34″ of this turbine through its junction with second exhaust gas outlet 28″.

Each line carries throttling means 58′ and 58″, such as a proportional valve, controlled by a control that may be common to the two throttling means. This valve thus allows controlling the circulation of the compressed air passing through the line.

Advantageously, each line also comprises a non-return valve 60′ and 60″, which prevents circulation of the compressed air from the line to the compressor.

In this configuration, recirculation line 62 is connected to the two transfer lines 54′ and 54″ by lines 62′ and 62″.

During operation, and as illustrated in FIG. 5, the engine can run with a turbine speed increase shown as the “Boost zone”, or with an exhaust gas recirculation shown as the “EGR zone”, or without turbine speed increase and without exhaust gas recirculation outside these two zones.

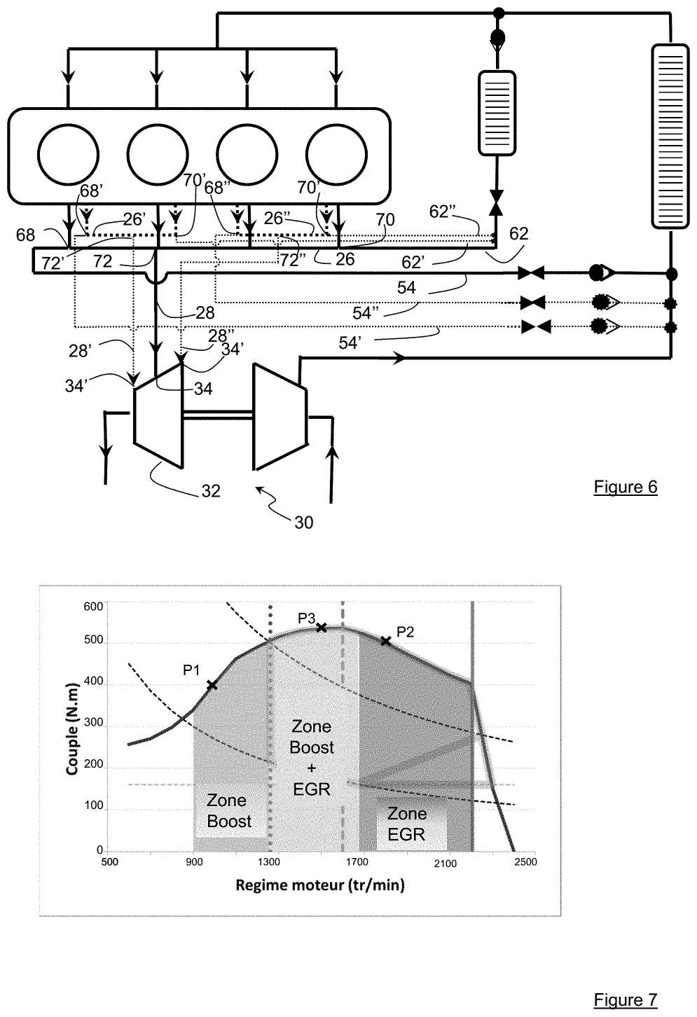

As illustrated in the second variant of FIG. 6, the engine can operate with either the turbine speed amplifier circuit (Boost) or with the exhaust gas recirculation circuit (EGR), or with both circuits.

Therefore, and for the Boost circuit and the EGR circuit to operate simultaneously, both circuits are connected on exhaust manifold 26 at two sufficiently spaced far apart points and outlet 28 sending the exhaust gas to inlet 34 of turbine 32 is positioned between the two points.

More precisely, in the case of a turbocharger 30 with a turbine 32 having a single inlet 34, transfer line 54 ends at a point 68 of the manifold and exhaust gas recirculation line 62 originates from another point 70 of the manifold distant from arrival point 68, and point 72 of outlet 28 sending the exhaust gas to inlet 34 of turbine 32 is positioned between these two points.

As mentioned for FIGS. 2 and 4, the turbocharger of FIG. 6 can be a turbocharger with a turbine 32 having two inlets 34′ and 34″, and the exhaust manifold can be divided into two distinct manifolds 26′ and 26″ with two outlets 28′ and 28″.

Thus, for manifold 26′, transfer line 54′ leads to a point 68′ of manifold 26′, exhaust gas recirculation line 62′ starts at another point 70′ of manifold 26′ and point 72′ of outlet 28′ sending the exhaust gas to inlet 34′ of turbine 32 is positioned between these two points.

Similarly, for manifold 26″, transfer line 54″ leads to a point 68″ of manifold 26″, exhaust gas recirculation line 62″ starts at another point 70″ of manifold 26″ and point 72″ of outlet 28″, which sends the exhaust gas to inlet 34″ of turbine 32, is positioned between these two points.

As shown in FIG. 7, the engine can operate with a turbine speed increase shown as the “Boost zone”, or with an exhaust gas recirculation shown as the EGR zone” marking, or with a turbine speed increase associated with an exhaust gas recirculation (“Boost+EGR zone”), or outside these three zones.

To ensure suitable operation of the engines described above, it is essential to use a control method so that the compression ratio of the air exiting the compressor and/or so that the amount of exhaust gas sent to the engine intake correspond to the operating points of these engines as contained in the designed engine map.

It is therefore necessary to use a method which knows the target compressed air flow rate (Qair obj) to be fed to the turbine according to a predetermined engine map giving the target compressed air flow rate (Qair obj) as a function of the engine operating point characteristics of speed, torque, etc., and which corrects the estimated air flow rate at the turbine inlet (Qair est) to approximate the target flow rate, in order to obtain the compression ratio of the air at the compressor outlet to be fed to the intake manifold to correspond to the engine operating point.

Thus, in general terms, with this method:
from an engine operating point, the target compressed air flow rate (Qair obj) to be fed to the turbine through the turbine speed amplifier circuit (Boost) is known, the real air flow rate (Qair est) fed to the turbine through the amplifier circuit (Boost) is estimated,
the two flow rates are compared, and
in case of a difference between the two flow rates, the air flow rate fed to the turbine through the amplifier circuit is controlled to correspond to the theoretical air flow rate.

It should be noted that several types of compressed air flow rate estimators can be considered.

Notably, a flow rate estimator with intake flow rate measurement and engine volumetric efficiency knowledge can be used:

In the case without EGR:
Intake air flow meter (compressor inlet)
Air flow rate map (Qair/Speed/P2/T2) from operations without BOOST
Boost ratio=((Qair mes/Qair theo (ss Boost))−1)
Boost flow rate=Boost ratio×Qair mes
Boost ratio=((Qair mes/Qair theo (ss Boost))−1)
Boost flow rate=Boost ratio×Qair mes

In case of use of Boost or EGR:
Intake air flow meter (compressor inlet)
Air flow rate map (Qair/Speed/P2/T2) from operations without BOOST and without EGR
Boost ratio/EGR=((Qair mes/Qair theo (ss Boost/EGR))−1)
Boost flow rate/EGR=Boost ratio/EGR×Qair mes

In case of use of Boost and/or EGR:
Intake air flow meter (compressor inlet)
Air flow rate map (Qair/Speed/P2/T2) from operations without BOOST and without EGR
Intake mixture richness probe
Boost ratio/EGR=((Qair mes/Qair theo (ss Boost/EGR))−1)
Boost flow rate/EGR=Boost ratio/EGR×Qair mes

A flow rate estimator measuring the richness at the exhaust can also be used.

In the case without EGR:
Exhaust richness (turbine outlet)
Exhaust richness map (Qair/Speed/P2/T2) from operations without BOOST
Boost ratio=((Qair mes/Qair theo (ss Boost))−1)
Boost flow rate=Boost ratio×Qair mes

In case of use of Boost or EGR:
Exhaust richness (turbine outlet)
Exhaust richness map (Qair/Speed/P2/T2) from operations without BOOST and without EGR
Boost ratio/EGR=((Qair mes/Qair theo (ss Boost/EGR))−1)
Boost flow rate/EGR=Boost ratio/EGR×Qair mes

In case of use of Boost and/or EGR:
Exhaust richness (turbine outlet)
Exhaust richness map (Qair/Speed/P2/T2) from operations without BOOST and without EGR
Intake mixture richness probe
Boost ratio/EGR=((Qair mes/Qair theo (ss Boost/EGR))−1)
Boost flow rate/EGR=Boost ratio/EGR×Qair mes.

With reference to the examples of FIGS. 1 and 2, and by way of example in order to better illustrate the invention, two operating points (P1 and P2) are selected (see FIG. 3) on the full-load operation curve in solid line.

One of the points, P1, requires amplification of the speed of turbine 32 (Boost zone) of turbocharger 30 in order to obtain, at the outlet of compressor 38, the desired air compression ratio to be allowed into the intake manifold.

The other point, P2, is in an operating zone where the amount of exhaust gas fed to the turbine through exhaust gas outlet 28 is sufficient to obtain the air compression ratio at the compressor outlet.

For operating point P1:
The amount of compressed air (Qair obj) to be fed to turbine 32 through transfer line 54 (or 54′, 54″) is known;
The amount of compressed air (Qair est) fed to the turbine through the transfer line is estimated;
The two amounts are compared, and
In case of a difference between these two amounts, opening or closing of valve 58 (or 58′, 58″) is controlled so that the amount of compressed air fed to the turbine corresponds to the estimated amount.

In the case of operating point P2, the amount of exhaust gas fed to the turbine through outlet 28 (or 28′, 28″) is sufficient to obtain the desired air compression ratio at the outlet of compressor 38.

Therefore, the estimation of the amount of compressed air to be allowed into turbine 32 corresponds to that of the target amount with a zero difference between the two amounts, and closing of valve 58 (or 58′, 58″) is controlled.

Thus, switching from the engine operation in the Boost zone to the other zone only requires closing valve 58 (or 58′, 58″).

The variant of FIG. 4 combines a turbine speed amplifier circuit (Boost circuit) and an exhaust gas recirculation (EGR) circuit for sending the gases to the engine intake manifold. These two circuits work alternately so as to meet the engine performances.

In this variant, the synergy between the use of the EGR circuit and the Boost circuit also involves a method allowing suitable control of the two circuits. This control is intended to make the most of the combination of the two circuits. This method thus allows controlling the opening and the closing of the valves to optimize engine response.

In order to better explain the method, two operating points (P1 and P2) are selected (see FIG. 5) on the full-load operation curve in the solid line.

Point P1 requires amplification of the speed of turbine 32 (Boost zone) of turbocharger 30 in order to obtain, at the outlet of compressor 38, the desired air compression ratio.

The other point, P2, is in an engine operating zone (EGR zone) where recirculation of the exhaust gas to the engine intake is necessary to limit pollutant emissions, notably NOx, and where the amount of exhaust gas fed to the turbine through exhaust gas outlet 28 is sufficient to obtain the air compression ratio at the compressor outlet.

In this variant, and for operating point P1:
The amount of compressed air (Qair obj) to be fed to turbine 32 through transfer line 54 (or 54′, 54″) is known;
The amount of compressed air (Qair est) fed to the turbine through the transfer line is estimated;
The two amounts are compared; and
In case of a difference between these two amounts, opening or closing of valve 58 (or 58′, 58″) is controlled so that the amount of compressed air fed to the turbine corresponds to the known amount (Qobj).

For operating point P2, the amount of exhaust gas fed to the turbine through outlet 28 (or 28′, 28″) is sufficient to obtain the desired air compression ratio at the outlet of compressor 38, and closing of valve 58 (or 58′, 58″) is controlled since the estimation of the amount of compressed air to be allowed into turbine 32 corresponds to that of the target amount.

Upon closing of valve 58 (or 58′, 58″), opening of valve 66 of the EGR circuit is controlled to allow exhaust gas into engine intake 18.

Conversely, when switching from the EGR zone to the Boost zone, closing of valve 66 of the EGR circuit is controlled and opening of valve 58 (or 58′, 58″) is controlled.

The variant of FIG. 6 also combines a turbine speed amplifier circuit (Boost circuit) and an exhaust gas recirculation (EGR) circuit for sending the gases to the engine intake manifold.

Unlike the variant of FIG. 4, these two circuits work alternately or simultaneously to meet the engine performances.

By way of example only, three operating points (P1, P2 and P3) are selected (see FIG. 7) on the full-load operation curve in the solid line.

Point P1 requires amplification of the speed of turbine 32 (Boost zone) of turbocharger 30 in order to obtain, at the outlet of compressor 38, the desired air compression ratio.

Point P2 is in an engine operating zone (EGR zone) where recirculation of the exhaust gas to the engine intake is necessary to limit pollutant emissions, notably NOx, and where the amount of exhaust gas fed to the turbine through exhaust gas outlet 28 is sufficient to obtain the air compression ratio at the compressor outlet.

Finally, point P3 is in an engine operating zone (Boost zone+EGR zone) where amplification of the speed of turbine 32 (Boost zone) of turbocharger 30 is required and where recirculation of the exhaust gas to the engine intake is also necessary to limit pollutant emissions, notably NOx, while allowing obtaining the desired air compression ratio at the outlet of compressor 38.

In this variant, and for operating point P1:
The amount of compressed air (Qair obj) to be fed to turbine 32 through transfer line 54 (or 54′, 54″) is known;
The amount of compressed air (Qair est) fed to the turbine through the transfer line is estimated;
The two amounts are compared; and
In case of a difference between these two amounts, opening or closing of valve 58 (or 58′, 58″) is controlled so that the amount of compressed air fed to the turbine corresponds to the estimated amount.

For operating point P3 of the EGR zone, the compressed air flow rate estimation is zero, which leads to the closing of valve 58 (or 58′, 58″) since the amount of exhaust gas fed to the turbine through outlet 28 (or 28′, 28″) is sufficient to obtain the desired air compression ratio at the outlet of compressor 38.

As for point P2, the speed amplifier circuit is controlled identically to that of point P1 (estimation+measurement+comparison), with the difference that controls the degree of opening or of the degree of closing of valve 58 (or 58′, 58″) is also dependent on the degree of opening of valve 66 of the EGR circuit for the amount of exhaust gas sent to the intake manifold. This allows obtaining an exhaust gas amount at the turbine inlet corresponding to the operating point demand.

1.-7. (canceled)

8. A method for controlling an amount of air fed to an intake of a turbocharged internal-combustion engine, the engine comprising an intake manifold and at least one exhaust gas outlet connected to an exhaust manifold, the turbocharger including a turbine having at least one inlet connected to the at least one exhaust gas outlet and an outside air compressor, and at least one turbine speed amplifier circuit with at least one transfer line for transferring compressed air from the compressor to the at least one turbine inlet and being controlled by throttling with a target compressed air flow rate fed to the turbine through the amplifier circuit which is known from an operating point and a predetermined engine map, comprising:
estimating a real air flow rate fed to the turbine through the amplifier circuit;
comparing the flow rates; and
controlling the air flow rate fed to the turbine through the amplifier circuit when there is a difference between the compressed air flow rate and the real air flow rate to correspond to the target air flow rate.

9. A method as claimed in claim 8, wherein the compressed air transfer from the compressor to the turbine inlet is shut off when a difference between the target compressed air flow rate and the estimated air flow rate is zero.

10. A method as claimed in claim 8, wherein the engine further comprises an exhaust gas recirculation circuit which sends exhaust gas to the intake manifold, wherein when the exhaust gas recirculation circuit operates, the turbine speed amplifier circuit is shut off.

11. A method as claimed in claim 9, wherein the engine further comprises an exhaust gas recirculation circuit which sends exhaust gas to the intake manifold, wherein when the exhaust gas recirculation circuit operates, the turbine speed amplifier circuit is shut off.

12. A method as claimed in claim 10, wherein when the turbine speed amplifier circuit is used the exhaust gas recirculation circuit is shut off.

13. A method as claimed in claim 11, wherein when the turbine speed amplifier circuit is used the exhaust gas recirculation circuit is shut off.

14. A method as claimed in claim 8, wherein the engine further comprises an exhaust gas recirculation circuit which sends the exhaust gas to the intake manifold, wherein for simultaneous use of the turbine speed amplifier circuit and of the exhaust gas recirculation circuit, the air flow rate fed to the turbine through the amplifier circuit is controlled to compensate for the recirculated exhaust gas flow rate.

15. A method as claimed in claim 9, wherein the engine further comprises an exhaust gas recirculation circuit which sends the exhaust gas to the intake manifold, wherein for simultaneous use of the turbine speed amplifier circuit and of the exhaust gas recirculation circuit, the air flow rate fed to the turbine through the amplifier circuit is controlled to compensate for the recirculated exhaust gas flow rate.

16. A method as claimed in claim 10, wherein the engine further comprises an exhaust gas recirculation circuit which sends the exhaust gas to the intake manifold, wherein for simultaneous use of the turbine speed amplifier circuit and of the exhaust gas recirculation circuit, the air flow rate fed to the turbine through the amplifier circuit is controlled to compensate for the recirculated exhaust gas flow rate.

17. A method as claimed in claim 11, wherein the engine further comprises an exhaust gas recirculation circuit which sends the exhaust gas to the intake manifold, wherein for simultaneous use of the turbine speed amplifier circuit and of the exhaust gas recirculation circuit, the air flow rate fed to the turbine through the amplifier circuit is controlled to compensate for the recirculated exhaust gas flow rate.

18. A method as claimed in claim 12, wherein the engine further comprises an exhaust gas recirculation circuit which sends the exhaust gas to the intake manifold, wherein for simultaneous use of the turbine speed amplifier circuit and of the exhaust gas recirculation circuit, the air flow rate fed to the turbine through the amplifier circuit is controlled to compensate for the recirculated exhaust gas flow rate.

19. A method as claimed in claim 8, wherein the compressed air flow rate is estimated by measuring an intake flow rate.

20. A method as claimed in claim 8, wherein the compressed air flow rate is estimated by measuring richness of exhaust from the engine.
